(19) United States
(12) Patent Application Publication
(10) Pub. No.: US 2005/0011169 A1
(43) Pub. Date: Jan. 20, 2005

(54) Safety stirrup

(76) Inventor: Peter Zillmer, Queensland (AU)

Correspondence Address: Hoffman Wasson & Gitler, 2361 Jefferson Davis Highway, Suite 522, Arlington, VA, 22202, US

(21) Appl. No.: 10/478,291

(22) PCT Filed: Apr. 9, 2002
(86) PCT No.: PCT/AU02/00445

(30) Foreign Application Priority Data
Apr. 9, 2001 (AU) PR 4306

(51) Int. Cl. B68C 3/00

(52) U.S. Cl. 54/49

(57) ABSTRACT

A safety stirrup (1) comprising an inverted U-shaped mounting member (2) having an adaptation (4) in the arcuate portion of the U for attachment of a stirrup strap thereto, a foot support (3) pivotally mounted between the extremities of the mounting member (2) when the stirrup is in normal use, wherein the foot support (3) comprises a tread (9) having an extension projecting upwardly from each end of the tread (9), the distal ends of which extensions join to form a loop (10). The stirrup also has co-operating engagement means (13, 14) between the foot support (3) and the inverted U-shaped mounting member (2) to retain the loop (10) of said foot support (3) in a plane generally coincident with a central plane of the inverted U-shaped mounting member (2) when the stirrup is in normal use. Rotation of the foot support (3) from the normal in use position disconnects the pivotal mountings (13, 14) and allows separation of the foot support (3) from the mounting member (2).

### TECHNICAL FIELD

This invention relates to horse riding stirrups and is particularly concerned with safety stirrups, which prevent the rider's foot from being caught in the stirrup in the event of the inadvertent dismounting of the rider such as being thrown from the horse.

### BACKGROUND ART

Known types of stirrups generally include a D-shaped metal structure with a slot located in the centre of the arcuate portion of the D to enable the stirrup to be attached to a stirrup strap. In use, the rider's foot is inserted into the stirrup such that a base portion defined by an inner surface of the upright of the D of the stirrup locates against the sole of the rider's foot and the arcuate portion of the stirrup locates against the top of the rider's foot. In this way the rider's foot is held in place and is not easily dislodged from the stirrup when the gait of the horse increases.

A disadvantage of existing stirrups is that in the event of the rider falling from the saddle, one of the rider's feet can become caught in the stirrup. This is particularly the case when a rider is thrown from the horse, the swiftness of which does not allow the rider to extract a foot caught in a stirrup. Catching of a foot in a stirrup can cause serious injury or even death since the rider may be dragged along the ground beside the horse.

Safety stirrups have been devised to overcome the foregoing disadvantage of the common type of stirrup. One form of a safety stirrup includes a frangible or weakened portion of the stirrup located adjacent to the stirrup strap attachment slot. In use, this frangible portion is designed to break away if the rider's foot is caught in the stirrup when the rider is thrown from the saddle.

This frangible stirrup is satisfactory in that the rider is saved from injury, which may be caused by being dragged along the ground. However, the rider cannot easily remount, since the saddle now has only one operable stirrup, which increases the chance of the rider being thrown from the saddle should the horse increase its gait. Hence the rider should replace the broken frangible stirrup before continuing, which may be inconvenient or impossible.

A safety stirrup of the type including a frangible portion often does not prevent the rider from suffering leg injuries when the rider is thrown from the horse. Hence, they are only of limited benefit for novice or disabled riders. A further disadvantage of these stirrups is that they are more bulky than conventional stirrups in the region of attachment to the stirrup strap and this increased bulk often causes wear to the rider's clothing.

An alternative form of safety stirrup is disclosed in Australian Patent Application No. 62109/90. In this stirrup, the foot is held in a restraint, which separates when the restraint is pivoted out of the normal position of the restraint with a rider mounted on a horse. This pivoting will occur when the rider is thrown from the horse and the separation of the restraint results in release of the foot from the stirrup. A disadvantage of the stirrup described in 62109/90 is that a foot must be placed in the stirrup from a particular side for the release mechanism to operate. Use of the stirrup with the foot inserted from the wrong side prevents operation of the release mechanism.

Yet another form of safety stirrup is disclosed in International Application Number PCT/AU97/00398 (Publication No. WO 97/49635) which is a combination of the AU62109/90 stirrup and a safety stirrup described in International Application No. PCT/AU95/00332 (Publication No. WO 96/00185) by the present applicant. While the PCT/AU95/00332 provides a safety stirrup that can be used with a foot inserted from either side, the PCT/AU97/00398 stirrup has the same failing as the AU62109/90 stirrup in that the foot must be placed in the stirrup from a particular side for the release mechanism to work.

### SUMMARY OF THE INVENTION

It is an object of the present invention to provide a stirrup which alleviates or overcomes the disadvantages of existing stirrups, or provides an alternative to known stirrups.

According to the present invention there is provided a safety stirrup comprising:
an inverted U-shaped mounting member having an adaptation in the arcuate portion of the U for attachment of a stirrup strap thereto;
a foot support pivotally mounted between the extremities of the mounting member when the stirrup is in normal use, wherein the foot support comprises a tread having an extension projecting upwardly from each end of the tread, the distal ends of which extensions join to form a loop;
co-operating engagement means between the foot support and the inverted U-shaped mounting member to retain the loop of said foot support in a plane generally coincident with a central plane of the inverted U-shaped mounting member when the stirrup is in said normal use;
wherein rotation of said foot support from said normal in use position disconnects said pivotal mountings and allows separation of the foot support from the mounting member.

The term “normal use” is used in the preceding paragraph and hereafter to denote the configuration of the stirrup when a rider is mounted on a horse to which a pair of stirrups is fitted with each foot of the rider in respective stirrups of the pair. In this configuration, the foot support is retained within the mounting member by the engagement means in combination with the pivotal mounting of the foot support to the mounting member. The configuration allows the rider to perform all actions required of horse riding including standing in the stirrups.

On the rider falling or being thrown from the horse, a foot caught in the stirrup causes the foot support to rotate by pressure on the loop of the support. There is an opposite force on the mounting member via the stirrup strap, which is still attached to a saddle on the horse. The rotation of the foot support causes the support to separate from the mounting member thereby releasing the rider's foot from the stirrup.

The pivotal mounting of the foot support to the mounting member is typically by way of shafts or pins. The pins or shafts can extend from the inner faces of the arms of the mounting member. Alternatively, the pins or shafts can extend from the outer faces of the foot support at or near the ends of the foot plate. That is, the pins or shafts can extend from the extensions forming the loop of the foot support.

The pin or shaft of the pivotal mounting is received by an aperture in the other component of the stirrup. For example, pins projecting from the inner faces of the arms of the support member are received by apertures in the foot support near the foot plate. This will be explained in the following exemplification.

To allow separation of the foot support and the mounting member on rotation of the former, a slot or channel is provided which extends from the aperture to an edge of the component including the aperture. On rotation of the foot support to a sufficient degree with force applied to the support away from the mounting member, the pin or shaft can move along the slot or channel to effect disengagement of the foot support and the mounting member.

The pivotal mounting advantageously comprises pins, which have heads that prevent excessive spreading of the arms of the mounting member when the pins are located in the apertures of the other component of the stirrup. Advantageously, the heads stand slightly away from the adjacent surfaces of the component with apertures to provide gaps therebetween when pins are located in apertures. Depending on the nature of the co-operating engagement means between the foot support and the mounting member, the aforementioned gaps can facilitate disengagement of the foot support and the mounting member by allowing spreading of the arms of the mounting member.

In preferred embodiments where the pivotal mounting of the foot support to an arm of the mounting member includes a pin having a head, a recess is typically provided around the corresponding aperture, which recess can receive the head of the pin when the pin is located in the aperture. The bulk of the head advantageously lies within the recess resulting in the component having a substantially smooth surface.

The co-operating engagement means is preferably a projection formed on each extension of the foot support, adjacent to the ends of the foot plate, and an aligned socket formed on the inner face of the arms of the inverted U-shaped mounting member. The projection is suitably maintained within the socket to thereby prevent pivotal rotation of the foot support from the plane of the mounting member during normal use, by spring-biasing the sides of the mounting member against the restraining means. The projections can equally well be formed on the inwardly facing sides of the mounting member with corresponding sockets formed in the foot support.

The means for locating the stirrup strap in the mounting member can be a conventional arrangement such as a slot through which the strap is threaded, or a known toggle-type connection. The former arrangement is preferred.

Suitably, the tread of the foot support is in the form of a solid plate or slotted plate, which is oriented in a generally horizontal plane in use. Preferably the extensions formed on the tread are walls which are integrally formed with the ends of the tread.

The components of a stirrup according to the invention can be fabricated from any suitable material including metals, metal alloys and plastics materials. Preferred metals are aluminium and stainless steel while a preferred plastics material is carbon fibre.

Having broadly described the invention, a safety stirrup will now be exemplified with reference to the accompanying drawings briefly described hereafter.

### BRIEF DESCRIPTION OF THE DRAWINGS

FIG. 1 is an elevational view of a safety stirrup according to the invention with a partial cross-section at the lower right-hand corner of the drawing;

FIG. 2a to 2c are cross-sectional end elevations of the stirrup shown in FIG. 1 with the cross-section at a vertical plane through the centre of the stirrup.

### BEST MODE AND OTHER MODES OF CARRYING OUT THE INVENTION

With reference to the figures, there is shown stirrup 1 comprising mounting member 2 and foot support 3. Mounting member 2 includes a slot 4 for a stirrup strap and has pins 5 and 6 as part of pivotal mounting of foot support 3 to mounting member 2. Pins 5 and 6 have heads 7 and 8.

Foot support 3 has a foot plate 9 and extensions from the ends of the foot plate that meet to form a loop 10. The extensions adjacent the ends of foot plate 9 are expanded to essentially form a wall, one of which is indicated at item 11 of FIG. 2c. The walled sections of the foot support have apertures for receiving the shafts of pins 5 and 6. One such aperture can be seen at item 12 of FIG. 2c which also shows that the aperture is slotted to the edge of foot support 3 at the ends of foot plate 9.

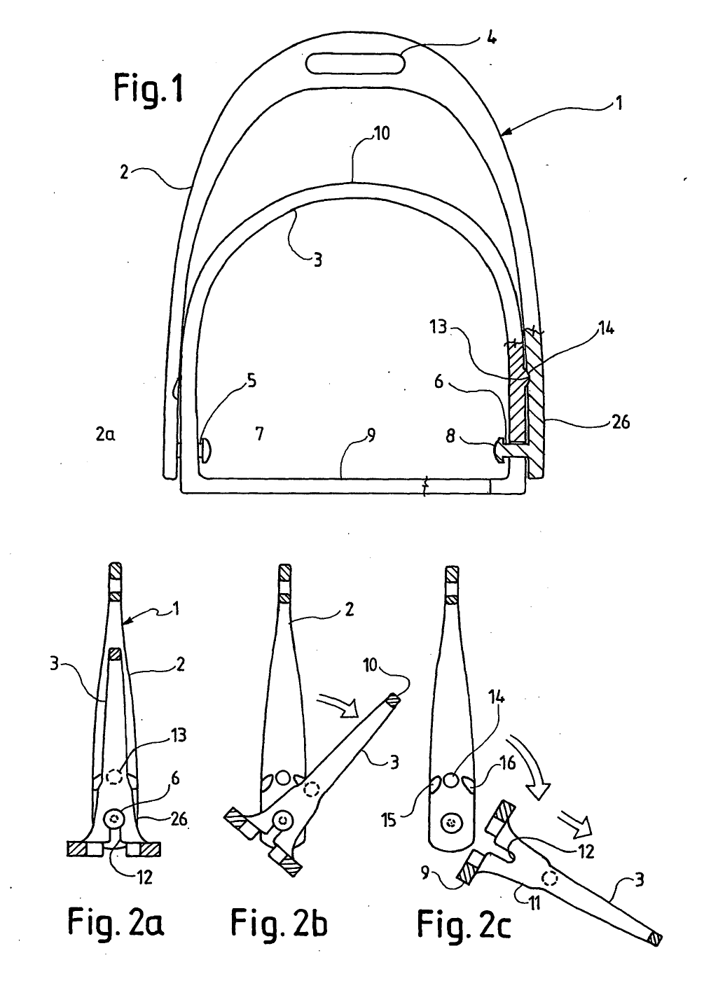

The co-operating engagement means of the stirrup comprises a hemispherical projection from the outer surface of each side of foot support 3. One such projection is shown at item 13. The projections dock in sockets provided on the inner faces of the arms 2a and 2b of support member 2. A socket is indicated at item 14 of FIGS. 1 and 2c. The arms of mounting member 2 are spring-biased towards each other, which holds each projection in its corresponding socket thereby locking the foot support in the in-use position within the mounting member. To aid pivoting of foot support 3 into the locked position within mounting member 2, grooves are provided at the edges of the inner faces of arms 2a and 2b of mounting member 2. A pair of grooves are items 15 and 16 of FIG. 2c.

Operation of the safety stirrup is shown in FIGS. 2a to 2c. The normal, in-use configuration of the stirrup is shown in FIG. 2a where foot support 3 is in position within mounting 2 with pin 6 in aperture 12. Foot support 3 is releasable locked in this position by docking of projection 13 in the socket in arm 2b. The socket is not visible in FIG. 2a.

The initial stage of separation of foot support 3 from mounting member 2 on a rider falling from a horse carrying stirrup 1 with a foot caught therein is shown in FIG. 2b. The pressure of the rider's foot against loop 10 causes foot support 3 to disengage from mounting member 2 and rotate away therefrom as generally indicated by the curved arrow.

Completion of the separation process is shown in FIG. 2c. Further rotation of foot support 3 past about 90° allows foot support 3 to slide off the pivot pins so that the support can separate from mounting member 2 as generally shown by the straight arrow. The rider's foot is then released from the stirrup.

Reassembly of stirrup 1 is a reversal of the release sequence depicted in FIGS. 2a to 2c.

It will be appreciated by one of skill in the art that many changes can be made to the safety stirrup as exemplified above without departing from the broad ambit and scope of the invention.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

The reference to the publications cited in the Background Art section of this specification is not an admission that the disclosures constitute common general knowledge in Australia.

1. A safety stirrup comprising:
an inverted U-shaped mounting member having an adaptation in the arcuate portion of the U for attachment of a stirrup strap thereto;
a foot support pivotally mounted between the extremities of the mounting member when the stirrup is in normal use, wherein the foot support comprises a tread having an extension projecting upwardly from each end of the tread, the distal ends of which extensions join to form a loop;
co-operating engagement means between the foot support and the inverted U-shaped mounting member to retain the loop of said foot support in a plane generally coincident with a central plane of the inverted U-shaped mounting member when the stirrup is in said normal use;
wherein rotation of said foot support from said normal in use position disconnects said pivotal mountings and allows separation of the foot support from the mounting member.

2. The stirrup according to claim 1, wherein said pivotal mounting is by way of shafts or pins.

3. The stirrup according to claim 2, wherein said shafts or pins extend from the inner faces of said arms of said mounting member.

4. The stirrup according to claim 2, wherein said shafts or pins extend from the outer faces of said foot support at or near the ends of said foot plate.

5. The stirrup according to claim 3, wherein said shafts or pins are received by apertures in said foot support near the ends of said foot plate, and wherein a slot or channel is provided from each said aperture to the edge of said foot support to allow disengagement of said foot support on rotation thereof.

6. The stirrup according to claim 4, wherein said shafts or pins are received by apertures near the ends of said arms of said mounting member, and wherein a slot or channel is provided from each said aperture to the edge of a said arm to allow disengagement of said foot support on rotation thereof.

7. The stirrup according to claim 2, wherein said pins of said pivotal mounting have heads which limit spreading of said arms of said mounting member.

8. The stirrup according to claim 7, wherein said heads of said pins are each received in a recess.

9. The stirrup according to claim 1, wherein said co-operating engagement means comprises a projection from each extension of said foot support adjacent to the ends of said foot plate, and a socket with which said projection is aligned when said stirrup is in normal use.

10. The stirrup according to claim 1, wherein said co-operating engagement means comprises a projection from each arm of said mounting member adjacent to the ends of said arms, and a socket with which said projection is aligned when said stirrup is in normal use.
